(19) United States
(12) Patent Application Publication
(10) Pub. No.: US 2013/0283664 A1
(43) Pub. Date: Oct. 31, 2013

(54) WIND-ACTIVATED BIRD DECOY

(71) Applicant: Anthony Kelly, Guelph (CA)

(72) Inventor: Anthony Kelly, Guelph (CA)

(21) Appl. No.: 13/458,547

(22) Filed: Apr. 27, 2012

(51) Int. Cl. A01M 31/06

(52) U.S. Cl. 43/3

(57) ABSTRACT

A bird decoy, such as the kind used for hunting, includes a body and head representative of the type of bird (e.g., goose, duck, turkey, etc.) being decoyed. The head is removably attached to a body. A wind rotation mechanism is inserted into the ground to support the decoy. The wind rotation mechanism can be attached to the head of the decoy and can include a shaft rotatably inserted into a tube. A tether can connect the decoy to a stake in the ground to constrain movement of the decoy. A set of such decoys includes a plurality of decoy bodies nested together in a stack.

### FIELD OF THE INVENTION

The invention relates to decoys for birds, such as waterfowl and game birds.

### BACKGROUND OF THE INVENTION

Decoys are known to be used to lure birds for a variety of reasons, such as for hunting. For a decoy to be effective, it should bear a degree of resemblance to the target species. Movement may also enhance effectiveness.

Conventional decoys suffer from a number of problems. The desire to make decoys closely mimic the target species has led to increased cost and complexity. For example, some decoys are injection molded and painted with a degree of accuracy that exceeds what is necessary to successfully lure the target species. Other decoys use electric motors to mimic movement of the target species, and this adds further complexity as well as the requirement for batteries. Moreover, known decoys, particularly complicated ones, may be bulky and challenging or time consuming to assemble. This can lead to difficulty in carrying and deploying a desired number of decoys.

### SUMMARY OF THE INVENTION

A bird decoy includes a head that is removably attached to a body. A wind rotation mechanism is inserted into the ground to support the decoy. The wind rotation mechanism can be attached to the head of the decoy and can include a shaft rotatably inserted into a tube. A tether can connect the decoy to a stake in the ground to constrain movement of the decoy. A set of such decoys includes a plurality of decoy bodies nested together in a stack.

### BRIEF DESCRIPTION OF THE DRAWINGS

The drawings illustrate, by way of example only, embodiments of the present invention.

FIG. 1 is a hidden-line perspective view of a bird decoy according to one embodiment.

FIG. 2 is an exploded side view of the bird decoy of FIG. 1.

FIG. 3a is a partial side view of another embodiment of the tube of the wind rotation mechanism.

FIG. 3b is a partial side view of another embodiment of the tube of the wind rotation mechanism.

FIG. 4 is a front view of a set of bird decoys of FIG. 1 arranged for storage, transport, or sale.

FIG. 5 is a perspective view of a bird decoy according to another embodiment.

FIG. 6 is a side view of a decoy head according to another embodiment.

### DETAILED DESCRIPTION OF THE INVENTION

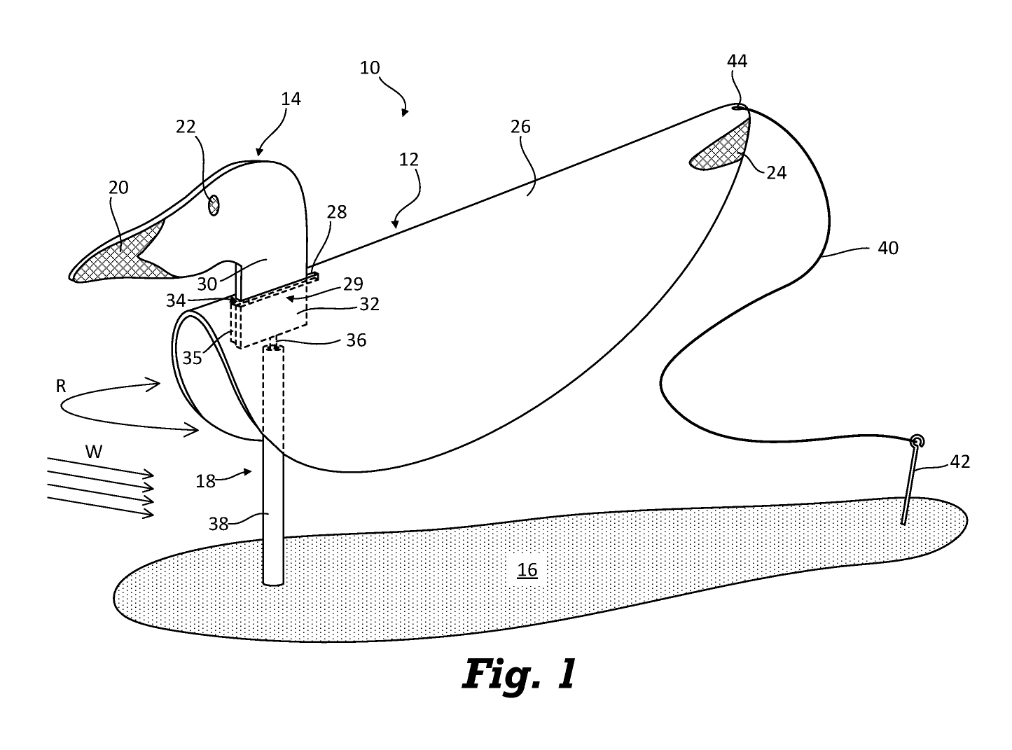

FIG. 1 shows a bird decoy 10 according to one embodiment of the invention. The bird decoy 10 can be representative of a waterfowl, game bird, or other variety of bird. Such birds include geese, ducks, turkeys, etc. The bird decoy 10 can be used in hunting and, for example, may be useful for luring birds to an area where they can be taken by a hunter. The decoy 10 is wind activated to increase the its effect in attracting birds.

The bird decoy 10 includes a body 12 and a head 14 supported above the ground 16 by a wind rotation mechanism 18 that is configured to be inserted into, or otherwise supported by, the ground 16. The body 12 and head 14 are shaped, sized, and ornamented to be representative of the particular type of bird being decoyed. The head 14 can include a beak marking 20 and eye marking 22 on each side and the body 12 can include tail markings 24 (one shown). In the example illustrated, the decoy 10 represents a snow goose. However, in other examples, other birds can be represented by changing any of the shape, size, and ornamentation of the body 12 and head 14.

The body 12 includes a shell 26, which in this embodiment is made of a single piece of curved sheet material. Suitable sheet materials include corrugated plastic, corrugated cardboard with a water-resistant coating, or similar material. When corrugated plastic is used, the shell 26 can be cut from a flat sheet and then bent or pressed under application of heat. The shell 26 is generally concave and open at one side (i.e., the bottom), so that several shells 26 can be stacked in a nested manner, as will be discussed in detail below. The shell 26 includes a slot 28 for receiving the head 14. The slot 28 can be cut in the shell 26 before or after the shell 26 is formed into shape.

The head 14 is a generally flat piece, which in this embodiment is made from flat sheet material. Suitable materials include those mentioned for the body 12. When corrugated plastic is used, the head 14 can be cut from a flat sheet and kept flat so as to be stackable. The head 14 may be shaped to be upright, as shown, or shaped so that the decoy 10 appears to be feeding from food on the ground 16. Other head shapes are also possible.

The head 14 is removably attached to the body 12. The head 14 includes a neck portion 29 that can be inserted into the slot 28 in the shell 26 of the body 12. The neck portion 29 has an upper portion 30 that extends upwards from the shell 26 and a lower portion 32 that extends downwards inside the shell 26. The neck portion 29 of the head 14 includes a notch 34 into which a portion of the shell 26 of the body 12 is inserted to secure the head 14 within the slot 28. Because the head 14 supports the body 12, the lower portion 32 of the head 14 can be thickened, by for example stapling or gluing a reinforcing piece 35 of corrugated sheet to the lower portion 32, so as to help the head 14 support the weight of the body 12.

The wind rotation mechanism 18 is attached to the head 14 and extends downwardly away from the body 12 in order to support both the head 14 and the body 12 above the ground 16. The wind rotation mechanism 18 includes a shaft 36 rotatably inserted into a tube 38. The shaft 36 is an elongated member of cylindrical or other cross-sectional shape and can be made of metal, plastic, or other suitable material. The tube 38 is an elongated member of cylindrical or other cross-sectional shape, has a hollow portion for receiving the shaft 36, and can be made of metal, plastic, or other suitable material. In this embodiment, the tube 38 is inserted into, or otherwise supported by, the ground 16 and the shaft 36 is attached to the lower portion 32 of the head 14. The shaft 36 can be inserted into an elongated gap afforded by the corrugated material of the head 14 and can be held in place by friction, glue, or other technique. Accordingly, the head 14 can be laid out on a sheet of corrugated material with reference to the orientation of the corrugations. In an alternate embodiment, the tube 38 is attached to the lower portion 32 of the head 14 and the shaft 36 is inserted into the ground 16. The notch 34 and reinforcing piece 35, if used, transfer the weight of the body 12 to the wind rotation mechanism 18. That is, the head 14 bears all of the weight of the body 12 and transfers this weight as well as its own weight to the wind rotation mechanism 18.

The bird decoy 10 further includes a tether 40 and a stake 42 or other anchor for limiting rotation of the decoy 10 due to wind. One end of the tether 40 is connected to the tail end of the body 12 by, for example, tying the tether to a hole 44 punched in the tail end of the shell 26. The other end of the tether 40 is connected to the stake 32. The tether 40 can be a length of nylon string or the like. The stake 42 can be a metal stake with one end suitable (e.g., a hooked end) for securing the tether 40. The stake 42 can be shaped to be readily inserted into the ground 16 by hand.

In use, the bird decoy 10 is assembled by inserting the head 14 into the slot 28 in the body 12 and mating the notch 34 of the head with the adjacent portion of shell 26 of the body 12. The tube 38 is inserted into the ground 16 where the decoy 10 is to be deployed. The shaft 36 is inserted into the tube 38. Then, the tether 40 is tied to the body 12 and the stake 42, which is inserted into the ground 16. Then, under influence of the wind, as indicated by arrows W, the decoy 10 rotates back and forth, as indicated by arrow R. The rotation of the decoy 10 is constrained by the position of the stake 42 and length of the tether 40, which can each be adjusted to achieve suitable movement for given conditions and desired decoying effect.

It should be apparent from the above that the decoy 10 is easy and quick to assemble and deploy. Further, the large but lightweight nature of the body 12 and head 14 allows the decoy 10 to move in even gentle breezes. It is also advantageous that the tether 40 anchors the decoy 10 to prevent the decoy 10 from spinning in the wind or even prevent the decoy 10 from being blown away in stronger winds. A further benefit is that the tether 40 and stake 42 can be adjusted to allow easy control of movement of the decoy 10 in response to changing wind conditions. In addition, unlike some known rotational limiting mechanisms, the stake 42 and tether 40 are simple to adjust while the decoy 10 is deployed. It is not necessary to undeploy the decoy 10 just to adjust its response to the wind.

The location of the wind rotation mechanism 18 with respect to the center of gravity of the decoy 10 can be selected to customize movement of the decoy 10. For example, if the wind rotation mechanism 18 is offset from the center of gravity by a significant amount, a moment develops between the shaft 36 and the tube 38 of the wind rotation mechanism 18. Such a moment can result in increased rotational friction to slow or dampen movement of the decoy 10. When the wind rotation mechanism 18 is closer to the center of gravity of the decoy 10, rotational friction is decreased, which may result in the decoy 10 moving in a gentler breeze. Accordingly, the specific location of the wind rotation mechanism 18 can be selected for a given design to advantageously achieve a desired decoying effect.

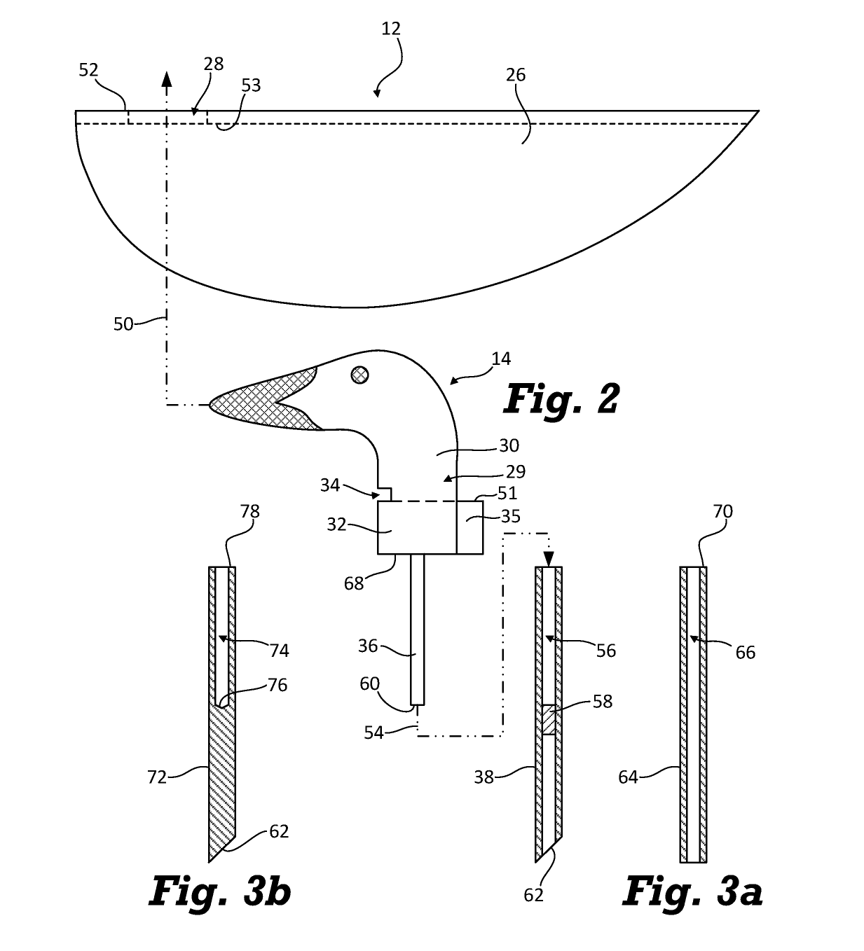

FIG. 2 shows a side view of the bird decoy 10 disassembled. During assembly, as shown by the phantom line 50, the head 14 is inserted through the slot 28 in the shell 26 of the body 12. If the lower portion 32 of the head 14 is thickened, for example by the reinforcing piece 35, then the head 14 can be inserted through the slot 28 beak first. The neck portion 29 of the head 14 is then positioned in the slot 28 so that the notch 34 in the head 14 aligns with a securing portion 52 of the shell 26 of the body 12. The head 14 is then pushed, leftward in the figure, so that the notch 34 mates with the securing portion 52 of the shell 26 in order to keep the body 12 attached to the head 14.

In addition, the reinforcing piece 35 may extend rearward from the neck portion 29 of the head 14, as shown in FIG. 2 (but not shown FIG. 1 for sake of clarity). A top surface 51 of the reinforcing piece 35 can then contact a lower surface 53 of the shell 26 of the body 12 when the head 14 is installed. This can increase the strength of the connection of the body 12 to the head 14.

Further during assembly, as shown by the phantom line 54, the shaft 36 is inserted into a bore 56 in the tube 38. A plug 58 is fixedly positioned in the bore to support a lower end 60 of the shaft 36. The plug 58 thus provides the bearing surface for the weight of the head 14 and attached body 12. In this embodiment, the shaft 38 has a chamfered or pointed lower end 62 to ease insertion into the ground 16.

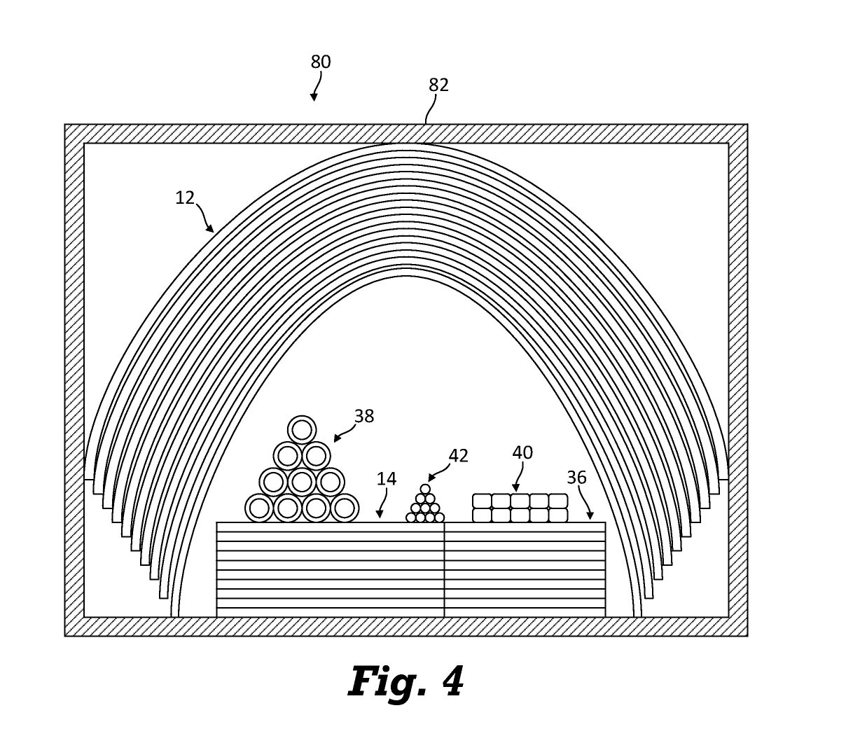

FIG. 3a shows an alternate embodiment of a tube 64 for use with the decoys described herein. The tube 64 has a bore 66. No plug is provided. Accordingly, the weight of the decoy's head 14 and attached body 12 is transferred via a bottom end 68 of the lower portion 32 of the head 14 resting upon a flat top end 70 of the tube 64. The tube 64 has flat ends, but the chamfered or pointed lower end 62 of the tube 38 can also be used.

FIG. 3b shows another alternate embodiment of a closed-end tube 72 for use with the decoys described herein. The tube 72 has a bore 74 that does not extend the full length of the tube 72. The tube 72 can be made from a length of round stock plastic or wood by drilling the bore 74 to a selected depth. The depth of the bore 74 can be selected so that the bottom 76 of the bore 74 contacts the lower end 60 of the shaft 36 and acts as the bearing surface for the weight of the head 14 and attached body 12. Alternately, the depth of the bore 74 can be made deeper so that the weight of the decoy's head 14 and attached body 12 is transferred via the bottom end 68 of the lower portion 32 of the head 14 resting upon a flat top end 78 of the tube 72. The tube 72 has the same chamfered or pointed lower end 62 as the tube 38, but a flat lower end, such as that of FIG. 3a, can also be used.

Selecting which tube 38, 64, 72 to use can be based on the decoy movement characteristics desired. The tubes 38, 72 may provide less rotational friction and thus smoother movement of the decoy 10, while the tube 64 may provide more rotational friction and thus more damped or slower movement of the decoy 10. Ease of manufacture and cost may also influence which tube 38, 64, 72 to use.

FIG. 4 illustrates a set 80 of bird decoys 10 arranged for storage, transport, sale, or other purpose. A box, bag, backpack, or other type of container 82 is used to hold a plurality of unassembled bird decoys 10. In this example, the set 80 includes 10 of the bird decoys 10, although more or fewer decoys 10 can be included.

A plurality of bodies 12 are arranged inside the container 82 in a nested stack. That is, each body 12 fits over the body 12 below due to the curved shape and flexibility of the bodies 12. The bodies 12 may deform somewhat when so stacked, but the resiliency of the sheet material used to make the bodies 12 can be selected such that the bodies 12 regain their original shape when unpacked.

A plurality of heads 14, each separate from its body 12 but with a shaft 36 attached, can be stacked in one or more stacks due to their generally flat shapes. The stack or stacks of heads 14 with attached shafts 36 can be arranged inside the container 82. A plurality of tubes 38 are also arranged inside the container 82 to complete with the plurality of shafts 36 a plurality of wind rotation mechanisms 18.

A plurality of tethers 40 and a plurality of stakes 42 can also be provide inside the container 82 to constrain movement of the decoys 10 to be assembled from the heads 14 and bodies 12.

As shown in FIG. 4, the concave nesting shape of the bodies 12 can allow for a very space efficient set 80 of decoys 10. Moreover, any or all of the heads 14, shafts 36, tubes 38, stakes 42, and tethers 40 can be stored inside the innermost body 12 of the stack, so as to achieve increased space efficiency. Sets 80 of decoys 10 can contain any number of decoys 10 practical. For example, decoys 10 can be provided in sets numbering 10, 20, 30, 50, or more. It is also advantageous that the lightweight material used for the bodies 12 and heads 14 as well as their stackable nature allow for many unassembled decoys to be transported. While in the past a trailer may have been required to transport a large number of conventional decoys, a large number of the decoys 10 can be transported in a backpack. Moreover, many of the lightweight and compact unassembled decoys 10 can be transported by aircraft to fly-in locations.

It is also noted that because the shells 26 of the bodies 12 have one dimension of curvature and because the heads 14 can be removed, the bodies 12 can be stacked more compactly than known shell style decoys.

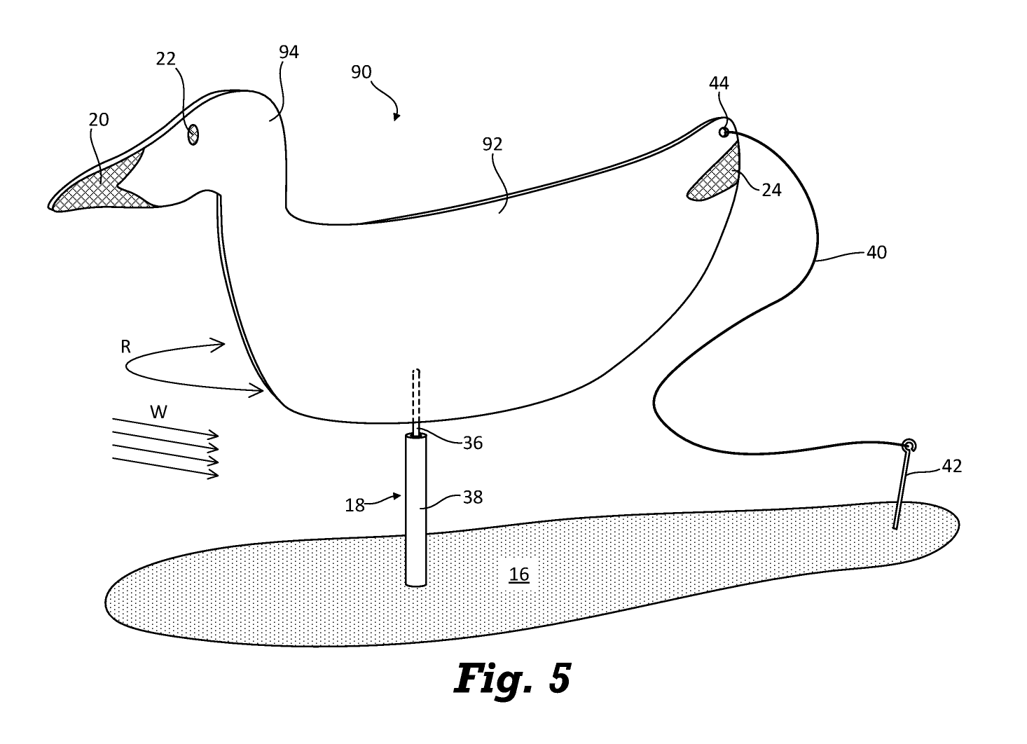

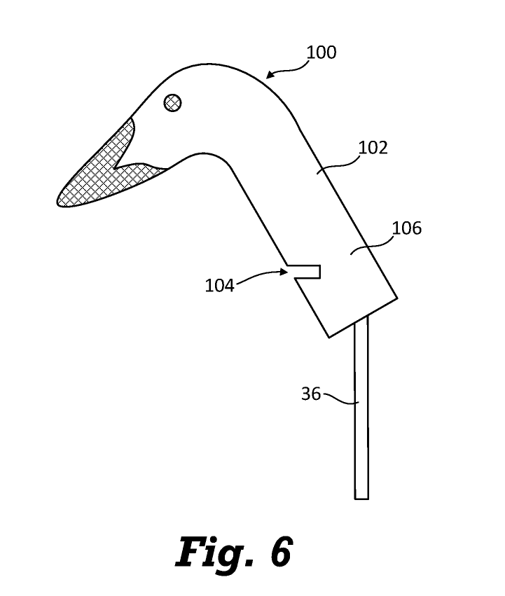

FIG. 5 shows a decoy 90 according to another embodiment of the invention. The decoy 90 is similar to the decoy 10 and shares many of the same advantages. Differences between the decoy 90 and the decoy 10 will be discussed in detail below. Like reference numerals denote like parts, and for further description of features and aspects of the decoy 90, the description of the decoy 10 can be referenced.

The decoy 90 is a silhouette style decoy. The decoy 90 is made of a single piece of sheet material, such as those materials described for the decoy 10. The decoy 90 includes a body portion 92 and a head portion 94 that are shaped, sized, and ornamented for the bird being decoyed. Suitable markings 20, 22, 24 can be provided.

The body portion 92 is attached to a wind rotation mechanism 18 that is inserted into the ground 16. For example, the shaft 36 may be glued or stapled to the body portion 92. When the body portion 92 is made of corrugated material, the shaft 36 may be inserted into a gap between corrugations, and may further be stapled or glued in place. The rotation of the decoy 90 due to the influence of the wind is constrained by a tether 40 connected between a hole 44 in the body portion 92 and a stake 42 that is inserted into the ground 16. The decoy 90 is thus deployed and operated in a manner similar to the decoy 10.

FIG. 6 shows a heads 100 for a decoy, such as the decoy 10, according to an alternate embodiment. The head 100 is similar to the head 14 and shares many of the same advantages. Differences between the head 100 and the head 14 will be discussed in detail below. Like reference numerals denote like parts, and for further description of features and aspects of the head 100, the description of the head 14 can be referenced.

The head 100 is made of a flat piece of material 102. The head 100 includes a slot 104 in a neck portion 106 for connection to the shell 26 of the decoy 10. The angle of the slot 104 with respect to the neck portion 106 can be selected to make it appear as if the decoy 10 has its head 100 tilted. In this example, the slot 104 angle is selected to tilt the head 100 forward and down. The shaft 36 of the wind rotation mechanism 18 can be connected to the head 100 to that it extends perpendicular to the slot 104 so that the body of the decoy 10 remains level. Alternately, the shaft 36 may extend at another angle, so that the body 12 of the decoy is also tilted. Generally, the angle of the slot 104 and the angle of the shaft 36 may each be selected to tilt the head 100 and body 12 as desired. It should be noted that the head 100 lacks a reinforcing piece, such as the reinforcing piece 35 (see FIG. 2), though one can be used if desired.

The wind rotation mechanism 18 and the tether 40 with stake 42, or other anchor, can be used alone or together with many different kinds of decoys, which are not limited to the shell and silhouette decoys described herein.

The decoys 10, 90 described herein are advantageously lightweight, weather-resistant, compact (especially when unassembled), inexpensive to make, easy to assemble, easy to transport (even without a vehicle), and do not require electrical power to operate, all without sacrificing effectiveness. A prototype of the decoy 10 was made and its effectiveness and advantages were confirmed.

While the foregoing provides certain non-limiting example embodiments, it should be understood that combinations, subsets, and variations of the foregoing are contemplated. The monopoly sought is defined by the claims.

What is claimed is:

1. A bird decoy comprising:
a body representative of a bird;
a head removably attached to the body, the head representative of the bird; and
a wind rotation mechanism attached to the head and extending away from the body, the wind rotation mechanism comprising a shaft rotatably inserted into a tube, the wind rotation mechanism configured to be inserted into the ground to support the head and attached body above the ground.

2. The bird decoy of claim 1, further comprising:
a tether having an end connected to the body; and
a stake connected to another end of the tether, the stake shaped to be inserted into the ground.

3. The bird decoy of claim 1, wherein the tube of the wind rotation mechanism is configured to be inserted into the ground and the shaft of the wind rotation mechanism is attached to the head.

4. The bird decoy of claim 1, wherein the body comprises a nesting stackable shell.

5. The bird decoy of claim 4, wherein the shell is formed of curved sheet material that is open on one side.

6. The bird decoy of claim 1, wherein the head comprises a stackable flat head piece.

7. The bird decoy of claim 1, wherein the body and the head are made of corrugated plastic sheet.

8. The bird decoy of claim 1, wherein the body comprises a slot through which the head is inserted.

9. The bird decoy of claim 8, wherein the head comprises a notch into which a portion of the body is inserted to secure the head to the body.

10. A bird decoy comprising:
a body representative of a bird;
a head removably attached to the body, the head representative of the bird;
a wind rotation mechanism configured to be inserted into the ground to support the head and attached body above the ground;
a tether having an end connected to the body; and
a stake connected to another end of the tether, the stake shaped to be inserted into the ground.

11. The bird decoy of claim 10, wherein the wind rotation mechanism is attached to the head and extends away from the body, the wind rotation mechanism comprising a shaft rotatably inserted into a tube.

12. The bird decoy of claim 11, wherein the tube of the wind rotation mechanism is configured to be inserted into the ground and the shaft of the wind rotation mechanism is attached to the head.

13. The bird decoy of claim 10, wherein the body comprises a nesting stackable shell.

14. The bird decoy of claim 13, wherein the shell is formed of curved sheet material that is open on one side.

15. The bird decoy of claim 10, wherein the head comprises a stackable flat head piece.

16. The bird decoy of claim 10, wherein the body and the head are made of corrugated plastic sheet.

17. The bird decoy of claim 10, wherein the body comprises a slot through which the head is inserted.

18. The bird decoy of claim 17, wherein the head comprises a notch into which a portion of the body is inserted to secure the head to the body.

19. A set of bird decoys comprising:
a plurality of bodies, each body representative of a bird, each body having a shell open on one side, the plurality of bodies arranged in a nested stack;
a plurality of heads separated from the bodies, each head representative of the bird, each head having a flat piece and configured to be attached to one of the bodies; and
a plurality of wind rotation mechanisms, each wind rotation mechanism configured to support an assembled head and body.

20. The set of bird decoys of claim 19, further comprising a plurality of tethers and a plurality of stakes, each tether for connecting each assembled head and body to one of the stakes to constrain movement of the assembled head and body.
